(19) United States
(12) Patent Application Publication
(10) Pub. No.: US 2015/0207603 A1
(43) Pub. Date: Jul. 23, 2015

(54) APPARATUS FOR TRANSMISSION ON LTE DEVICE TO DEVICE COMMUNICATION

(71) Applicant: Humax Holdings Co., Ltd., Yongin-si (KR)

(72) Inventors: Alex Chungku YIE, Incheon (KR); Yongjae LEE, Seongnam-si (KR); Jun Bae AHN, Gwangju-si (KR)

(21) Appl. No.: 14/603,288

(22) Filed: Jan. 22, 2015

(30) Foreign Application Priority Data
Jan. 23, 2014 (KR) 10-2014-0008371
May 16, 2014 (KR) 10-2014-0058952
May 16, 2014 (KR) 10-2014-0058953
May 16, 2014 (KR) 10-2014-0058954
Aug. 14, 2014 (KR) 10-2014-0106098
Nov. 14, 2014 (KR) 10-2014-0158951
Nov. 14, 2014 (KR) 10-2014-0158952
Nov. 18, 2014 (KR) 10-2014-0161109
Nov. 19, 2014 (KR) 10-2014-0161848
Jan. 22, 2015 (KR) 10-2015-0010859

(51) Int. Cl. H04L 5/00; H04L 5/14; H04W 56/00

(52) U.S. Cl. CPC H04L 5/0048; H04W 56/001; H04L 5/14

(57) ABSTRACT

The present invention relates to device-to-device communication that is performed in an efficient type that is used for device-to-device communication. That is, the present invention relates to an apparatus for transmission on LTE device-to-device communication which can perform device-to-device communication at a high speed with a bandwidth and a transmission type, in which interference can be minimized. The apparatus includes a first terminal that performs device-to-device communication by transmitting a synchronization signal for terminals and a discovery signal to a second terminal and receiving a response to the signals from the second terminal.

### BACKGROUND OF THE INVENTION

1. Field of the Invention

Exemplary embodiments of the present invention relate to an apparatus for transmission on LTE device-to-device communication, and more particularly, to device-to-device communication in an efficient transmission type used for device-to-device communication. That is, exemplary embodiments of the present invention relate to an apparatus for transmission on LTE device-to-device communication which can perform device-to-device communication at a high speed with a bandwidth and a transmission type, in which interference can be minimized.

2. Description of the Related Art

Wireless communication uses various standards and protocols for data transmission between a base station and a terminal. OFDM (Orthogonal Frequency-Division Multiplexing) for high-speed transmission is used as a modulation technique for wireless communication.

Standards and protocols using OFDM are used in 3GPP (third generation partnership project) LTE (long term evolution), IEEE (Institute of Electrical and Electronics Engineers) 802.16, and IEEE 802.11 standards.

In a 3GPP LTE system, a base station may be a combination of an E-UTRAN (Evolved Universal Terrestrial Radio Access Network) Node Bs (also called, advanced Node Bs, improved Node Bs, eNodeBs, or eNbs) and an RNC (Radio Network Controller) and communicates with a terminal that is user equipment (UE). In IEEE 802.16, a base station may be expressed as ‘BS’ (Base Station). In IEEE 802.11, a base station may be expressed as WiFi WAP (Wireless Access Point).

At present, a base station is used in device-to-device communication. The reason is that using a base station to schedule radios resources reduces load on terminals and is efficient. However, when communication is made directly between terminals, not through a base station, due to some reasons such as a short distance between terminals or multiplexing of radio resources, it is possible to more effectively increase efficiency of a communication system, so a study for improving communication efficiency between terminals has been conducted.

For example, a control method for device-to-device communication has been stated in Korean Patent Application Publication No. 10-2013-0070661. The patent document provides a method of receiving location information of terminals by means of base stations and allocating resources for device-to-device communication in accordance with a selected resource allocation method, in order to efficiently allocate resources for device-to-device communication.

Other than the allocation of resources, it is required to smoothly demodulate communication data and prevent interference by another communication entity in order to achieve efficient device-to-device communication. However, there are many base stations and terminals on common wireless communication systems, so another base station and another terminal are likely to interfere with communication between terminals. Further, there is a possibility of an error in demodulating of communication data between terminals due to fading in a frequency period and/or a time period in a wireless communication environment.

Accordingly, for device-to-device communication, there is a need for developing a plan capable of effectively and efficiently demodulating communication data and of preventing interference by another communication entity.

### DOCUMENTS OF RELATED ART

### Patent Document

Korean Patent Application Publication No. 10-2013-0070661 (Jun. 28, 2013)

### SUMMARY OF THE INVENTION

An object of the present invention is to provide an apparatus for transmission on LTE device-to-device communication which performs device-to-device communication in an efficient transmission type used for device-to-device communication.

Another object of the present invention is to provide an apparatus for transmission on LTE device-to-device communication which efficiently uses wireless channels by performing device-to-device communication at a high speed with a bandwidth and a transmission type, in which interference can be minimized.

In accordance with an embodiment of the present invention, an apparatus for transmission on LTE device-to-device communication includes: an RF unit that transmits and receives wireless signals; and a processor that is connected to the RF unit, in which the processor may perform device-to-device communication by transmitting a synchronization signal for terminals and a discovery signal to a second terminal and receiving a response to the signals from the second terminal.

The processor may use, as a parameter, at least any one of using a value under a specific value of codes under ½ as a turbo code and using ½ as a default, of using 80 MHz or less as a bandwidth and using 20 MHz as a default, of using any one of FDD and TDD as a duplex mode and using TDD as a default, of using any modulation type under 64QAM as a modulation type and using 64QAM as a default, and of using ‘normal’ and ‘extended’ as a cyclic prefix (CP) and using ‘normal’ as a default.

The synchronization signal between terminals may include a PD2DSS (primary D2D synchronization signal) and an SD2DSS (secondary D2D synchronization signal). When the extended CP symbol is used, the PD2DSS may be positioned at the number zero or the number one of the first slot of a sub-frame and the SD2DSS may be positioned at the number three or the number four of the second slot of the sub-frame.

In accordance with another embodiment of the present invention, an apparatus for transmission on LTE device-to-device communication includes: an RF unit that transmits and receives wireless signals; and a processor that is connected to the RF unit, in which the processor may perform device-to-device communication with a second terminal and may not receiving at least any one period of time and frequency that are not necessarily received in signals from the second terminal.

When there are frequencies that are not necessarily received and there are five or less sub-carriers of 1024 sub-carriers that are necessarily received, the processor may reduce the processing time by using at least any one of reducing the processing time using DFT instead of FFT signal processing, reducing the processing time by demodulating only necessary sub-carriers in the FFT signal processing, and reducing the processing time by performing FFT signal processing with an LUT (look up table) for sub-carriers that are necessarily received.

In accordance with another embodiment of the present invention, an apparatus for transmission on LTE device-to-device communication includes: an RF unit that transmits and receives wireless signals; and a processor that is connected to the RF unit, in which the processor may perform device-to-device communication with a second terminal and transmits data by performing interleaving on a physical channel that is used for device-to-device communication.

The processor may perform at least any one of interleaving in a frequency range and interleaving in a time range.

The processor may not perform interleaving in at least any one type of not performing the interleaving on an interleaving reference symbol when performing the interleaving in a frequency range, not performing the interleaving on an interleaving reference sub-carrier when performing the interleaving in a time range, and not performing the interleaving on an interleaving reference sub-carrier at the interleaving reference symbol when performing the interleaving in both the frequency range and the time range.

The processor may perform at least any one of designating one or more symbol per sub-frame as the interleaving reference symbol, designating one or more sub-carriers per sub-frame as the interleaving reference sub-carrier, and designating a different interleaving reference sub-carrier for each symbol.

The processor may perform at least any one of punchuring in the frequency range and punchuring in the time range on at least any one of before and after the interleaving.

When a wireless channel environment between the apparatus and the second terminal is good, the processor may perform punchuring over the number of times of punchuring, which is performed for a poor wireless channel environment. The processor may perform punchuring over the number of times of punchuring performed for a high-level modulation type, when a low-level modulation type is used.

The processor may perform automatic gain adjustment on the basis of an automatic gain adjustment reference symbol of device-to-device communication symbols transmitted from the second terminal. The processor may demodulate the symbols that have undergone the automatic gain adjustment, on the basis of automatic gain values in the automatic gain adjustment.

When a wireless channel environment between the apparatus and the second terminal is poor, the processor may perform automatic gain adjustment, using reference symbols over the number of the automatic gain adjustment reference symbols used for a good wireless channel environment. The processor may perform automatic gain adjustment, using reference symbols over the number of the automatic gain adjustment reference symbols used for a low-level modulation type, when a high-level modulation type is used.

In accordance with an embodiment of the present invention, an apparatus for transmission on LTE device-to-device communication includes: an RF unit that transmits and receives wireless signals; and a processor that is connected to the RF unit, in which the processor may receive information about an adjacent base station from at least any one of a base station and a second terminal and performs device-to-device communication with the second terminal.

The processor may keep the information about sixteen or less adjacent base stations and then perform device-to-device communication by minimizing interference with the adjacent base stations, or may keep the information about basically three or less adjacent base stations, further keep the information about maximum sixteen base stations when it is insufficient, and then perform device-to-device communication by minimizing interference with the adjacent base stations.

There is a communication problem over a communication problem standard value in communication with the second terminal, the processor may expand the information about adjacent base stations, and when there is a communication problem under the communication problem standard value in communication with the second terminal, the processor may remove the information about adjacent base stations from the base station farthest from the apparatus.

The processor may keep the locations of the information about adjacent base stations as relative distances such as one-dimensional, two-dimensional, and three-dimensional distances from the apparatus. The processor may additionally receive at least any one the information of frequencies, frequency bands, transmission power, and coverage of adjacent base stations, in addition to the locations of adjacent base stations.

According to an apparatus for transmission on LTE device-to-device communication of the present invention, it is possible to perform device-to-device communication in an efficient type used in device-to-device communication.

Further, according to an apparatus for transmission on LTE device-to-device communication of the present invention, it is possible to efficiently use a wireless channel by performing device-to-device communication at a high speed with a bandwidth and a transmission type, in which interference can be minimized.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating the configuration of an LTE network according to an exemplary embodiment of the present invention;

FIG. 2 is a diagram illustrating the configuration of dual connectivity when a first base station of FIG. 1 operates as a main base station and a second base station operates independently as a sub-base station;

FIG. 3 is a diagram illustrating the configuration of dual connectivity when the first base station of FIG. 1 operates as a main base station, the second base station operates as a sub-base station, and data is separated and combined through the main base station;

FIG. 4 is a diagram illustrating a configuration in detail when the sub-base station of FIGS. 2 and 3 is disconnected from a terminal;

FIG. 5 is a diagram illustrating a configuration in detail when transmission power for a terminal is allocated to the main base station or the sub-base station of FIGS. 2 and 3;

FIG. 6 is a diagram illustrating a configuration in detail when a terminal randomly accesses the main base station or the sub-base station of FIGS. 2 and 3;

FIG. 7 is a diagram illustrating the configuration of a communication system for LTE device-to-device communication according to another exemplary embodiment of the present invention;

FIG. 8 is a diagram illustrating a configuration for a second terminal of FIG. 7 to demodulate a sub-carrier;

FIG. 9 is a diagram illustrating interleaving by a terminal of FIG. 7;

FIG. 10 is a diagram illustrating a configuration for a terminal of FIG. 7 to keep information about an adjacent base station; and

FIG. 11 is a block diagram illustrating a wireless communication system for which exemplary embodiments of the present invention can be achieved.

### DESCRIPTION OF SPECIFIC EMBODIMENTS

Detailed exemplary embodiments of the present invention will be described with reference to the accompanying drawings.

The present invention may be modified in various ways and implemented by various exemplary embodiments, so that specific exemplary embodiments are illustrated in the drawings and will be described in detail below. However, it is to be understood that the present invention is not limited to the specific exemplary embodiments, but includes all modifications, equivalents, and substitutions included in the spirit and the scope of the present invention.

Hereinafter, an apparatus for transmission on LTE device-to-device communication according to the present invention is described in detail with reference to the accompanying drawings.

Device-to-device communication is one of communication types which is made not through a base station, requires a method of synchronizing terminals by matching time and a frequency of terminals, a method of finding a terminal to communicate with after synchronization of terminals, and a method of performing device-to-device communication after finding a terminal.

First, the synchronization between terminals is achieved by a D2DSS (Device to Device Synchronization Signal) and a PD2DSCH (Physical D2D Synchronization Channel).

The D2DSS is used for synchronizing time and a frequency between a first terminal and a second terminal by being transmitted from the first terminal and received by the second terminal. The PD2DSCH means a physical channel through which such as D2DSS is transmitted.

When a cellular network to which a base station pertains is not available, the D2DSS provides the function of an existing synchronization signal transmitted from the base station. That is, it allows for synchronization for D2D communication of terminals and carries ID information of a subject that provides a common time reference.

When a cellular network normally operates, D2D terminals can obtain and use a common time reference from their base stations. For example, in an LTE system, a terminal obtains time synchronization and a cell ID of a cell to which it pertains, by accessing a base station and detecting a PSS (Primary Synchronization Signal) and an SSS (Secondary Synchronization Signal) that are synchronization signals from the base station, and can use the obtained time synchronization for a common time reference.

On the other hand, in the method of finding a terminal, a first terminal is required to transmit discovery information to another around in order to inform the second terminal of its existence in D2D communication. Further, the second terminal can recognize the existence of the first terminal by receiving the discovery information.

When the second terminal recognizing the discover information transmits data to the first terminal, it transmits information about itself to the first terminal, in which control information for receiving the information may be transmitted together.

The first terminal receiving the information about the second terminal transmits ACK/NACK and/or close loop control information to the second terminal on the received signal, thereby achieving communication.

Thereafter, device-to-device communication uses a physical channel and the physical channel is composed of a plurality of traffic slots. Further, link scheduling and data transmission are independently performed for each of the traffic slots, in which there are link scheduling, transfer rate scheduling, data transmission, and acknowledgement transmission.

In the link scheduling, it is possible to measure the relationship of signal interference between terminal links and determine whether it is possible to transmit data, that is, whether it is possible to access or concede a medium, by transmitting a single-tone detection signal using an OFDM signal architecture for each terminal link for unidirectional communication.

A detailed transfer rate is adjusted for links, to which access is determined by a corresponding traffic slot in the transfer rate scheduling, transmission terminals of links, to which access is determined, transmit data to corresponding reception terminals in the data transmission, and an acknowledgement message for data transmission can be transmitted in the acknowledgement transmission.

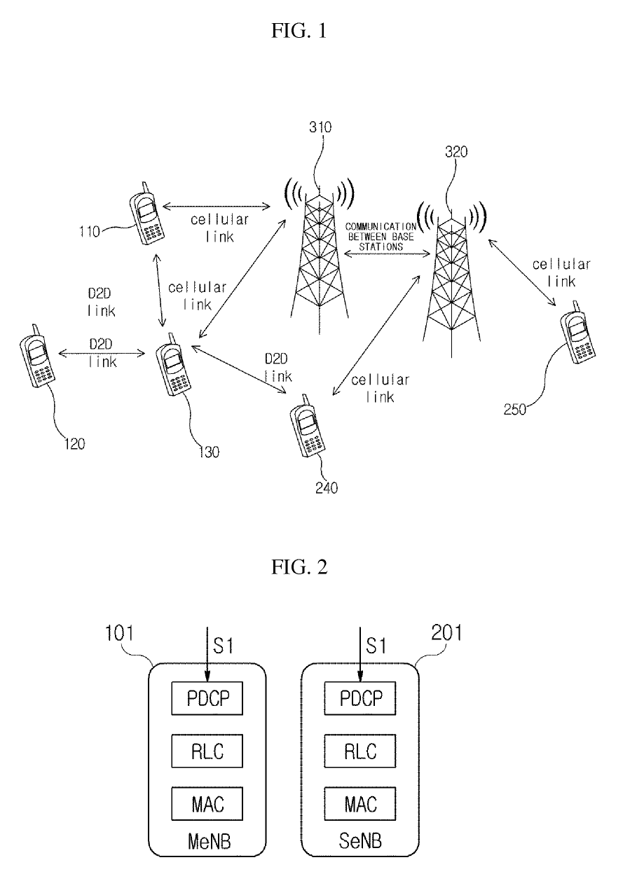

FIG. 1 is a diagram illustrating the configuration of an LTE network according to an exemplary embodiment of the present invention and FIGS. 2 to 6 are diagrams illustrating the configuration of FIG. 1 in detail.

An apparatus for transmission on LTE device-to-device communication according to an exemplary embodiment of the present invention is described hereafter with reference to FIGS. 1 to 6.

Referring to FIG. 1 first, an LTE network structure according to an exemplary embodiment of the present invention is composed of base stations and terminals. In particular, new frequencies can be allocated and used for inter-terminal communication, when a macrocell and a D2D channel are specifically allocated.

When a macrocell and a D2D channel are both allocated, inter-terminal communication may be achieved by at least any one of adding a sub-channel and using the physical channel used by the macrocell, and at least any one of a channel allocation scheme, a channel management scheme, and a duplexing method may be used for interference between the macrocell and the D2D channel.

Further, synchronization between terminals may be provided from at least any one of an uplink, a downlink, and both of an uplink and a downlink.

In the LTE network structure, in detail, a first terminal 110 and a third terminal 130 are in the cellular link coverage of a first base station 310, and a fourth terminal 240 and a fifth terminal 250 are in the cellular link coverage of a second base station 320.

The third terminal 130 is positioned at a distance where D2D communication with the first terminal 110, the second terminal 120, and the fourth terminal 240 is available. The D2D link of the third terminal 130 and the first terminal 110 is in the same first base station 310, the D2D link of the third terminal 130 and the fourth terminal 240 is on another cellular coverage, the D2D link of the third terminal 130 and the second terminal 120 is formed by the second terminal 120 not positioned in any cellular coverage and the third terminal 130 positioned in the cellular coverage of the first base station 310.

The cellular link channel used between the first base station 310 and the third terminal 130 and the D2D link channel used by the third terminal 130 and the fourth terminal 240 may be separately or simultaneously allocated.

For example, when the cellular link channel used between the first base station 310 and the third terminal 130 and the D2D link channel used by the third terminal 130 and the fourth terminal 240 use the same frequency, OFDM symbols of PDSCH, PDCCH, PUSCH, and PUCCH may be separately allocated.

In particular, the first base station 310 can carry out an allocation schedule of time slots for transmitting a synchronization signal, a discovery signal, and an HARQ for the D2D link channel used by the third terminal 130 and the fourth terminal 240.

The synchronization signal transmitted by the first base station 310 may be used simultaneously with the information about the cellular link of the first base station 310, but the time slots for transmitting a synchronization signal, a discovery signal, and an HARQ for the third terminal 130 and the fourth terminal 240 may be scheduled not to overlap the time slots of the cellular link channels used between the first base station 310 and the third terminal 130.

When the cellular link channel used between the first base station 310 and the third terminal 130 and the D2D link channel used by the third terminal 130 and the fourth terminal 240 use different frequencies, the third terminal 130 and the fourth terminal 240 can exclusively use the OFDM symbols of PDSCH, PDCCH, PUSCH, and PUCCH, and the third terminal 130 or the fourth terminal 240 can perform scheduling.

D2D communication between the third terminal 130 and the fourth terminal 240 is performed, avoiding interference influenced by the first base station 310 and the first terminal 110. In particular, in the D2D communication between the third terminal 130 and the fourth terminal 240, the third terminal 130 uses any one of a way of transmitting a synchronization signal received from the first base station 310 to the fourth terminal 240 through the uplink channel used by the first base station 310, a way of transmitting the synchronization signal to the fourth terminal 240 through the downlink channel used by the first base station 310, and a way of transmitting the synchronization signal to the fourth terminal 240 through both of the uplink and downlink channels used by the first base station 310.

Elements for D2D data communication are described hereafter with reference to another exemplary embodiment.

First, D2D data communication may be composed of discovery for finding a D2D terminal and D2D communication for actual communication after the discovery.

Discovery is composed of signals and messages for finding a D2D terminal and discovery information and channel estimation information are included in the signals and messages.

Frames for messages and sequences of the discovery may be used similar to a PUSCH (physical uplink shared channel) of an LTE uplink, local discovery uses a normal cyclic prefix, and a long-range discovery uses an extended cyclic prefix.

A QPSK, a turbo code, an interleaver, and a CRC-24 are used for transmitting messages and sequences of the discovery.

The messages and sequences of the discovery are transmitted at the same time and the same frequency.

D2D communication, which is used for communication between terminals, uses physical channels for synchronization and communication between terminals.

Synchronization in D2D communication is for synchronizing terminals by transmitting a D2D synchronization signal and uses the same frequency and time between terminals.

A synchronization sequence of D2D communication includes at least one of a ZC sequence and an M sequence.

The content of synchronization in D2D communication includes at least any one of the ID of a synchronization source that transmits a synchronization signal, the type of the synchronization source, resource allocation for a control signal, and data.

A physical channel for D2D communication includes at least any one of a D2DSS (D2D Synchronization Signal) for transmitting a D2D synchronization signal, a PD2DSCH (Physical D2D Synchronization Channel) that is a physical D2D synchronization channel, a CH-CCH (Cluster head control channel) that is a cluster head control channel, a CH-DCH (Cluster head data channel) that is a cluster head data channel, a D2D data channel, and an REQ (request) channel for requesting a resource.

The D2DSS is transmitted from a cluster head that is the synchronization source of a cluster composed of D2D terminals and provides a synchronization reference.

Further, PD2DSCH includes an SFN, synchronization information showing a synchronization state, a channel bandwidth, and setting information showing resource setting information, in a cluster head.

Further, the CH-CCH is transmitted from a cluster head to a transmission terminal and a reception terminal in a cluster, includes transmission information for transmission, and does not include a control part for decoding.

Further, the CH-DCH, similarly, is transmitted from a cluster head to a transmission terminal and a reception terminal in a cluster and transmits data to be transmitted, in accordance with scheduling of the CH-CCH.

A D2D data channel, which is a channel for transmitting data from a transmission terminal to a reception terminal in a cluster, transmits data through a resource allocated by monitoring CH-CCH information.

The REQ channel is a channel that is used, when a transmission terminal requests resource allocation to a cluster head. A D2S buffer state, indirection information measured by a transmission terminal, and available transmission power are requested, and the REQ channels of several transmission terminals are separated in accordance with frequencies and transmitted to the cluster head.

Therefore, the D2DSS, PD2DSCH, CH-CCH, and CH-SCH used for transmission from a cluster to a terminal, the REQ channel used for transmission from a terminal and a cluster head, and the D2D data channel used between terminals use any one of LTE PB CH (physical broadcast channel), PSS/SSS (primary synchronization signal/secondary synchronization signal), PDCCH (physical downlink control channel), PUCCH (physical uplink control channel).

FIG. 2 is a diagram illustrating a configuration of dual connectivity when the first base station 310 of FIG. 1 operates as a main base station 101 and the second base station 320 operates independently as a sub-base station 201.

The main base station 101 (master eNB) and the sub-base station 201 (secondary eNB), which are used for dual connectivity, are individually connected with a core network.

Accordingly, all of protocols are independent from the main base station 101 and the sub-base station 201, and particularly, data to be transmitted to two base stations is not separated and combined at the base stations.

A PDCP (Packet Data Convergence Protocol) is one of wireless traffic protocol stacks in LTE which compresses and decompresses an IP header, transmits user data, and keeps a sequence number for a radio bearer.

RLC (Radio Link Control) is a protocol stack of controlling wireless connection between a PDCP and MAC.

MAC (Media Access Control) is a protocol stack supporting multi access on a wireless channel.

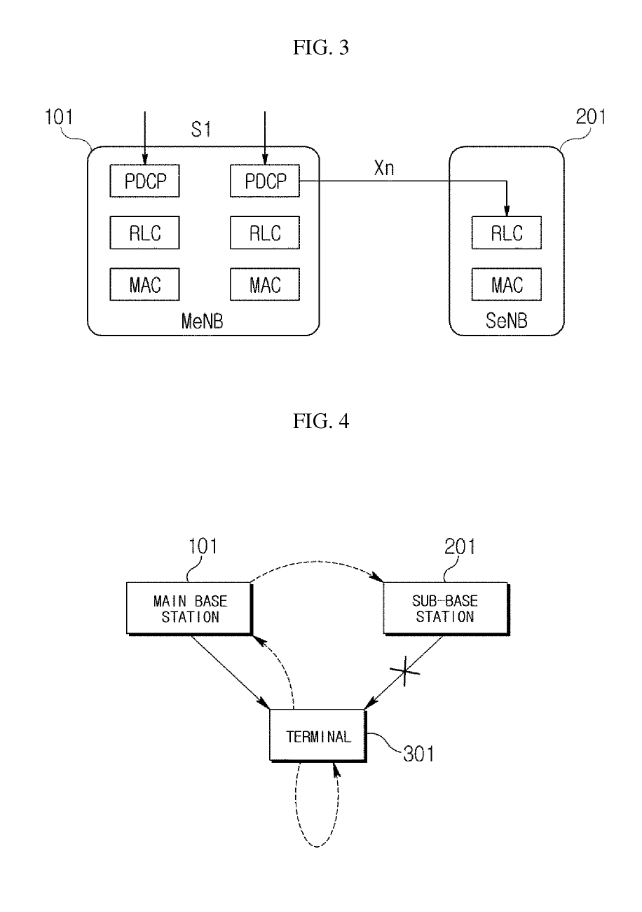

FIG. 3 is a diagram illustrating a configuration of dual connectivity when the first base station 310 of FIG. 1 operates as a main base station 101, the second base station 320 operates as a sub-base station 201, and data is separated and combined through the main base station 101.

That is, when the main base station 101 and the sub-base station 201, which are used for dual connectivity, are connected with a core network, only the main base station 101 is connected with the core network and the sub-base station 201 is connected with the core network through the main base station 101.

Accordingly, data transmitted/received on the core network is separated and combined by the main base station 101. That is, data separated from the main base station 101 is transmitted to the sub-base station 201 or data received from the sub-base station 201 is combined and transmitted/received on the core network.

FIG. 4 is a diagram illustrating a configuration in detail when the sub-base station 201 of FIGS. 2 and 3 is disconnected from a terminal 301.

That is, the apparatus for transmission on LTE device-to-device communication includes the main base station 101 that allocates a wireless resource to the terminal 301 and performs data communication with the terminal 301, the sub-base station 201 that performs data communication with the terminal 301 simultaneously with the main base station 101, and the terminal that simultaneously performs data communication with the main base station 101 and the sub-base station 201, and resets wireless resource control when it unlinks from the sub-base station 201.

When the terminal 301 is not normally connected with the sub-base station 201, it informs the main base station 101 of connection state information and the main base station 101 informs the sub-base station 201 of the link state information between the sub-base station 201 and the terminal 301.

Similarly, when the terminal 301 is abnormally connected with the main base station 101, the terminal 301 resets wireless resource control and reports it to the sub-base station 201 and the sub-base station 201 reports the abnormal connection to the main base station 101.

The communication between the main base station 101 and the sub-base station 201 may be performed by adding information to a frame in an X2 interface or by a broadband network, and when they are not connected by a wire, wireless backhaul may be used for the communication. A signal system including a link state header showing the link state of the main base station 101 and the sub-base station 201, a link state, a base station ID, and a terminal ID may be used for the information in the frame.

Accordingly, when there is a problem with connection in any one of the main base station 101 and the sub-base station 201, the terminal 301 reports it to any one of the main base station 101 and the sub-base station 201, which has no problem, and the base station receiving the report informs the base station with the problem with connection of the report so that the state of connection with the terminal 301 can be checked.

On the other hand, when there is a problem with connection in both of the main base station 101 and the sub-base station 201, similarly, the terminal 301 resets the wireless resource control to allow for communication with the base stations.

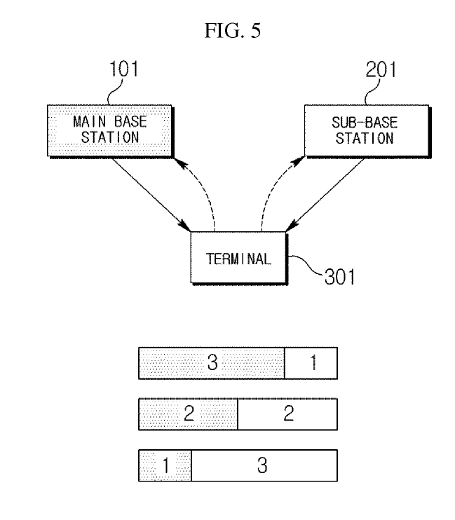

FIG. 5 is a diagram illustrating a configuration in detail when transmission power for the terminal 301 is allocated to the main base station 101 or the sub-base station 201 of FIGS. 2 and 3.

That is, the apparatus for transmission on LTE device-to-device communication includes the main base station 101 that allocates a wireless resource to the terminal 301 and performs data communication with the terminal 301, the sub-base station 201 that performs data communication with the terminal 301 simultaneously with the main base station 101, and the terminal 301 that sets an upper limit ratio of transmission power for the main base station 101 and the sub-base station 201 on the basis of statistic analysis on power sent out from the main base station 101 and the sub-base station 201.

The statistic analysis is analyzing a transmission power ratio on the basis of the average power sent out from the terminal 301 to the main base station 101 and the sub-base station 201, and the terminal 301 reports the upper limit ratio of transmission power to the main base station 101 and the sub-base station 201.

That is, the terminal 301 sets the power ratio to send out to the main base station 101 and the sub-base station 201 on the basis of the average value of the maximum power, which can be sent out by the terminal 301, and the transmission values sent out to the main base station 101 and the sub-base station 201.

For example, it sets the ratio of power to send out to the main base station 101 and the sub-base station 201 as 3:1, 2:2, and 1:3.

As another example, when power to be sent is distributed, first, it is very important to maintain connectivity with the main base station 101 or transmit a control signal, so, in order to transmit the signal, power may be allocated to the main base station 101 first and then the remaining power may be distributed for data transmission/reception with the sub-base station 201.

As another example, the power available for transmitting data to the sub-base station 201 may be dynamically changed. That is, an MCS (Modulation and Coding Scheme) value may depend on the available power, even if the wireless channel does not change.

A data transmission error may be generated, when the power distribution and the MCS value are simultaneously changed, so that a change of the power distribution and a change of the MCS value may not be simultaneously performed.

Alternatively, when the power distribution and the MCS value are simultaneously changed, a period of reporting a CQI (Channel Quality Indicator) for changing the MCS, which is a feedback signal system, may be set not to be generated simultaneously with the change of the power distribution, in order to prevent a data transmission error.

On the other hand, at least any one of the maximum value of a terminal, the ratio of power that is being used, the maximum transmission power for each base station according to a power ratio, and the margin of the maximum power, which can be transmitted to the base stations, to the power currently sent out to the terminal can be reported to the main base station 101 and the sub-base station 201.

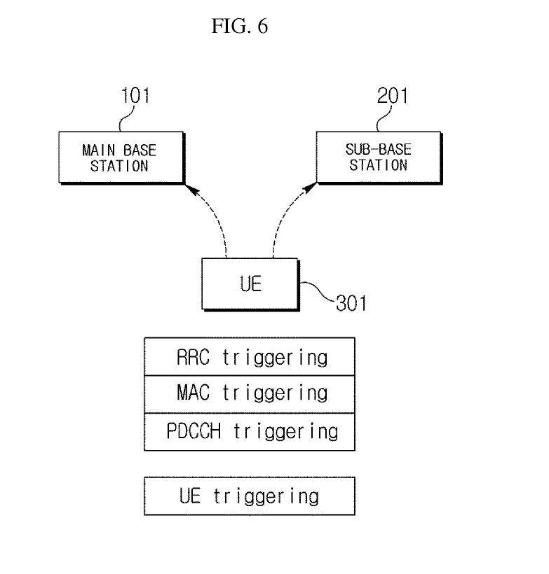

FIG. 6 is a diagram illustrating a configuration in detail when the terminal 301 randomly accesses the main base station 101 or the sub-base station 201 of FIGS. 2 and 3.

That is, the apparatus for transmission on LTE device-to-device communication includes the main base station 101 that allocates a wireless resource to the terminal 301 and performs data communication with the terminal 301, the sub-base station 201 that performs data communication with the terminal 301 simultaneously with the main base station 101, and the terminal 301 that sends out any one of random access to the main base station 101 and the sub-base station 201 by triggering and self random access to them without triggering to at least any one of the main base station 101 and the sub-base station 201.

The triggering is performed by any one triggering command of PDCCH, MAC, and RRC and the sub-base station 201 includes a base station, which can be accessed first, of base stations that can operate as the sub-base station 201.

The random access is transmitted in any one type of a preamble without contents, initial access, a wireless resource control message, and a terminal ID>

That is, the random access, which is used for initial access to the main base station 101 or the sub-base station 201, establishment and re-establishment of wireless resource control, and handover, may be sent out to any one of the main base station 101 and the sub-base station 201 or simultaneously to the main base station 101 or the sub-base station 201.

Random access may be sent out by PDCCH, MAC, and RRC (Radio Resource Control) triggering from the main base station 101 or the sub-base station 201, but it may be sent out by triggering of a terminal itself.

Further, random access may be sent out by using the remaining power except for the power distributed to an uplink.

On the other hand, when the main base station 101 or the sub-base station 201 is newly turned on, an error may be generated in data communication due to simultaneous random access of surrounding terminals, including the terminal 301.

Accordingly, in order to reduce such influence, the terminal 301 may perform random access, additionally using a random time around ten seconds, when the main base station 101 or the sub-base station 201 is newly turned on. The ‘ten seconds’ is the maximum random access time that is variable in accordance with the number of terminals and the number of base stations and the maximum random access time may be any one in the range of one second to sixty seconds, depending on the environment.

Meanwhile, since the terminal 301 can use a multi-antenna, it is possible to minimize interference influence by finding the transmission position of the main base station 101 or the sub-base station 201 and performing random access toward the main base station 101 or the sub-base station 201.

Alternatively, when the exact positions of the main base station 101 and the sub-base station 201 are not found, the terminal 301 may perform random access by sweeping at 360 degrees.

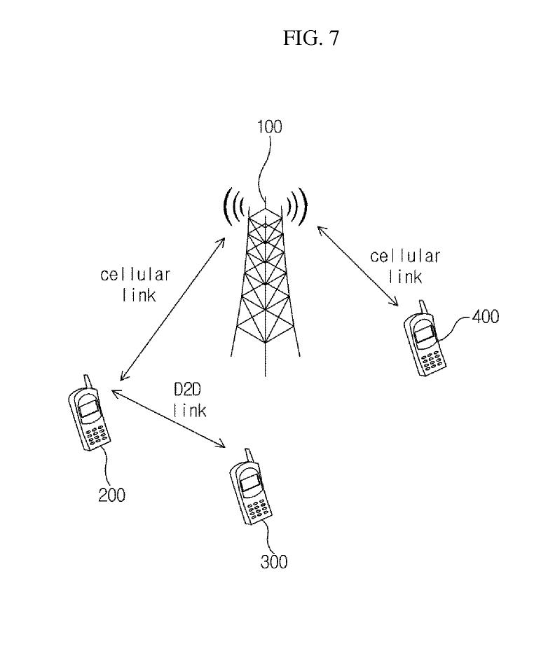

FIG. 7 is a diagram illustrating the configuration of a communication system for LTE device-to-device communication according to another exemplary embodiment of the present invention. The system may include a base station 100, a first terminal 200, and a second terminal 300. The first terminal 200 may perform device-to-device communication by transmitting a synchronization signal for terminals and a discovery signal to the second terminal 300 and receiving a response to the signals from the second terminal 300.

The terminal 200 may use, as a parameter, at least any one of using a value under a specific value of codes under ½ as a turbo code and using ½ as a default, of using 80 MHz or less as a bandwidth and using 20 MHz as a default, of using any one of FDD and TDD as a duplex mode and using TDD as a default, of using any modulation type under 64QAM as a modulation type and using 64QAM as a default, and of using ‘normal’ and ‘extended’ as a cyclic prefix (CP) and using ‘normal’ as a default.

Further, a synchronization signal between terminals may include a PD2DSS (primary D2D synchronization signal) and an SD2DSS (secondary D2D synchronization signal). When the extended CP symbol is used, the PD2DSS may be positioned at the number zero or the number one of the first slot of a sub-frame and the SD2DSS may be positioned at the number three or the number four of the second slot of the sub-frame.

That is, when the first terminal 200 performs direct communication with the second terminal 300, the second terminal 300 may be close to or far from the first terminal 200. Accordingly, appropriate ones are used for the turbo code, the bandwidth, the duplex, the modulation type, and the cyclic prefix in accordance with cases.

First, as for the turbo code for removing an error according to the quality of wireless channels, a value under a specific value of codes under ½, which is the maximum of the turbo code, is used in preparation for a poor channel state between terminals, and ½ is used as a default in preparation for a poor channel state.

Further, as for the frequency bandwidth to be used, 20 MHz or more, which is the minimum bandwidth, and 80 MHz or less, which is the maximum bandwidth, are used and 20 MHz that is the minimum is used as a default in consideration of interference.

As for the way of separating transmission and reception, both of FDD (Frequency Division Duplex) based on a frequency and TDD (Time Division Duplex) based on time may be used. When the FDD is used for communication between terminals, the transmission/reception frequencies for communication with the base station 100 may be changed, so the first terminal 200 or the second terminal 300 may equipped with transmission/reception hardware for two frequencies.

However, when the TDD is used, they may be equipped with only transmission/reception hardware for one frequency. Accordingly, in communication between the first terminal 200 and the second terminal 300, a duplex mode uses both the FDD and TDD and the transmission/reception hardware may use the TDD as a default.

The modulation type uses 64QAM at the maximum on the assumption that a wireless environment channel is good, and 64QAM capable of performing transmission three or more times faster than QPSK may be used as a default.

As for the cyclic prefix that is guide time allowing for restoration of a signal of fading in accordance with a wireless environment, it may be possible to use ‘normal’ and ‘extended’ in consideration of the distance between terminals and to use ‘normal’ as a default, assuming that the first terminal 200 and the second terminal 300 are close to each other.

The D2DSS (D2D Synchronization signal) that is a synchronization signal between terminals may transmit a PD2DSS (primary D2DSS) and an SD2DSS (secondary D2DSS) to achieve exact synchronization.

When a normal CP is used and when an extended CP is used, the number of symbols of OFDM to be transmitted to a time slot in a sub-frame capable of transmitting a PD2DSS and an SD2DSS is defined differently due to the length of the CPs. That is, when the normal CP is used, fourteen symbols (zero to thirteenth) OFDM symbols are used for one time slot, and when the extended CP is used, twelve (zero to eleventh) OFDM symbols are used for one time slot.

In order to maintain exact synchronization, the PD2DSS and the SD2DSS each may continuously use two OFDM symbols. When the normal CP is used in this case, the PD2DSS may be positioned at the number 1 and the number 2 at the first time slot and the SD2DSS may be positioned continuously at the number 4 and the number 5, using two time slots composed of fourteen OFDM symbols per time slot.

However, when the extended CP is used, one time slot is composed of twelve OFDM symbols, so the positions of the PD2DSS and the SD2DSS may be changed.

For example, the PD2DSS may be positioned at the number 1 and the number 2 of the first time slot and the SD2DSS may be continuously positioned at the number 4 and the number 5 of the second time slot without changing OFDM symbols, or when OFDM symbols are transmitted at one previous period, the PD2DSS may be positioned at the number 0 and the number 1 of the first time slot and the SD2DSS may be positioned continuously at the number 3 and the number 4 of the second time slot, or when OFDM symbols are transmitted later at one period, the PD2DSS may be positioned at the number 2 and the number 3 of the first time slot and the SD2DSS may be positioned at the number 5 and the number 6 of the second time slot.

By the arrangement of synchronization signals between terminals, the present invention can maintain exact synchronization and easily demodulate of synchronization signals.

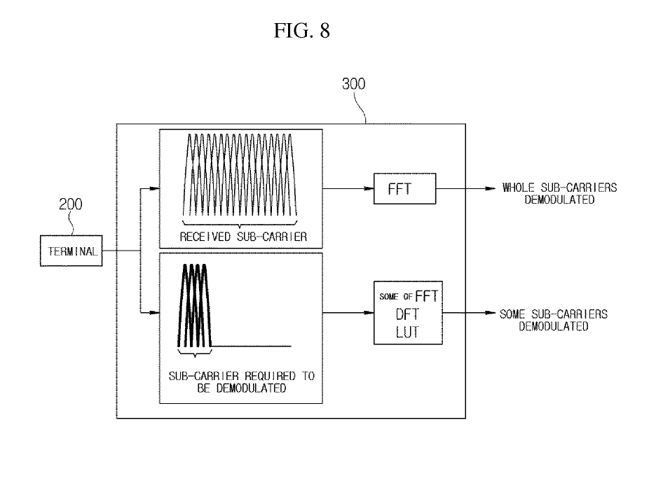

FIG. 8 is a diagram illustrating a configuration for a second terminal of FIG. 7 to demodulate a sub-carrier.

The apparatus for transmission on LTE device-to-device communication includes a first terminal 200 that performs device-to-device communication with a second terminal 300 that does not receive periods of time and a frequency, which are not necessarily received, in a signal from the second terminal 300.

When there are frequencies that are not necessarily received and five or less sub-carriers of 1024 sub-carriers that are necessarily received are used, the terminal 200 reduces the processing time by using at least any one of reducing the processing time using DFT instead of FFT signal processing, reducing the processing time by demodulating only necessary sub-carriers in the FFT signal processing, and reducing the processing time by performing FFT signal processing with an LUT (look up table) for sub-carriers that are necessarily received.

That is, since frames that are not necessarily received are not received, a battery can be saved and the battery can be saved in unnecessary frequency ranges. When FTT (Fast Fourier Transform) needs to be performed at a time in accordance with a frequency band, it is required to demodulate the entire frequency bandwidth, so it takes unnecessary processing time when there is a need for demodulating only some sub-carriers.

Accordingly, by performing DFT on only necessary sub-carriers, it is possible to reduce the processing speed. There is a remarkable different in accordance with the algorism between the FFT and the DFT (Discrete Fourier Transform), but on the assumption that the number of sub-carriers is N and the number of sub-carriers to be demodulated is M, when a memory is not used, the calculation amount of the DFT is defined as N*M and the calculation amount of the FFT is defined as N/2*log 2(N).

That is, when there are 1,024 sub-carriers, the DFT has 1,048,576 clocks and the FFT has 5,120 clocks. However, the FFT has a defect that it has to calculate the whole sub-carriers, but the DFT has an advantage that it can separately calculate sub-carriers.

Accordingly, when there are a small number of sub-carriers to be demodulated, the calculation amount is reduced by the DFT, so the battery can be saved.

For example, when only five of 1,024 sub-carriers are demodulated and the DFT is used, only 5,120 clocks are used, so the calculation amount of DFT is reduced when sub-carriers not more than five sub-carriers are demodulated.

As another method of demodulating some sub-carriers, only necessary parts may be calculated in FFT. That is, the FFT demodulates sampling data in a received time range in several steps, in which when minimum necessary sub-carriers are demodulated, the calculation amount can be reduced. For example, when adjacent sub-carriers are not demodulated, the calculation amount of at least one clock for two sub-carriers can be reduced.

On the other hand, repeated types of sub-carriers can be quickly calculated through an LUT (Look Up Table). There is a defect that a large amount of memory is used when an LUT is used, but it is very efficient when the positions of sub-carriers to be demodulated are determined and there are a small number of sub-carriers to be demodulated. That is, the calculation amount can be one clock for one sub-carrier.

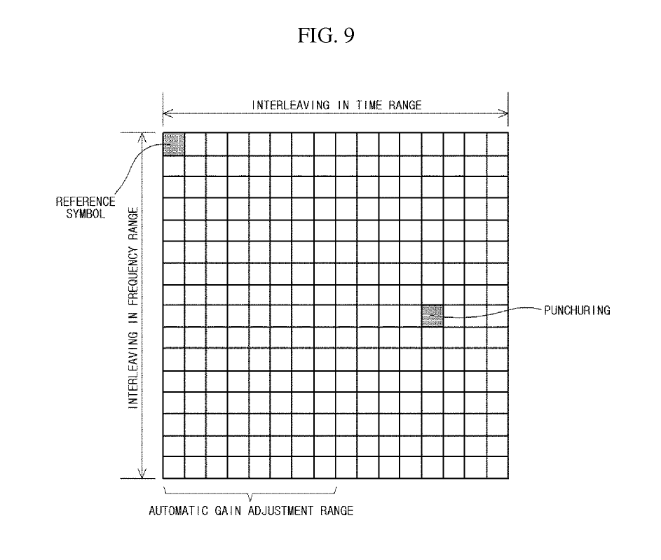

FIG. 9 is a diagram illustrating interleaving by a terminal of FIG. 7.

The apparatus for transmission on LTE device-to-device communication includes a first terminal 200 that performs device-to-device communication with a second terminal 300 and transmits data by performing interleaving on a physical channel that is used for device-to-device communication.

The first terminal 200 may perform at least any one of interleaving in a frequency range and interleaving in a time range.

The first terminal 200 is characterized by not performing interleaving on an interleaving reference symbol when it performs interleaving in a frequency range, by not performing interleaving on an interleaving reference sub-carrier when it performs interleaving in a time range, and by not performing interleaving on an interleaving reference sub-carrier at the interleaving reference symbol when it performs interleaving in both the frequency range and the time range.

The first terminal 200 may use at least any one of designating one or more symbol per sub-frame as the interleaving reference symbol, designating one or more sub-carriers per sub-frame as the interleaving reference sub-carrier, and designating a different interleaving reference sub-carrier for each symbols.

The first terminal 200 may perform at least any one of punchuring in the frequency range and punchuring in the time range on at least any one of before and after interleaving.

When the wireless channel environment between the first terminal 200 and the second terminal 300 is good, the first terminal 200 may perform punchuring over the number of times of punchuring, which is performed for a poor wireless channel environment.

The first terminal 200 may perform punchuring over the number of times of punchuring performed for a high-level modulation type, when a low-level modulation type is used.

The first terminal 200 can perform automatic gain adjustment on the basis of an automatic gain adjustment reference symbol of device-to-device communication symbols transmitted from the second terminal 300.

Further, the first terminal 200 can demodulate the symbols that have undergone the automatic gain adjustment, on the basis of automatic gain values in the automatic gain adjustment.

When the wireless channel environment between the first terminal 200 and the second terminal 300 is poor, the first terminal 200 may perform automatic gain adjustment, using automatic gain adjustment reference symbols over the number of the automatic gain adjustment reference symbols used for a good wireless channel environment.

The first terminal 200 can perform automatic gain adjustment, using automatic gain adjustment reference symbols over the number of the automatic gain adjustment reference symbols used for a low-level modulation type, when a high-level modulation type is used.

The present invention for performing device-to-device communication between the first terminal 200 and the second terminal 300 can perform interleaving to compensate fading in which attenuation is temporarily generated in a frequency range and a time range which are generated in a wireless environment.

The interleaving may be performed in the time range or the frequency range, or may be performed in both the time range and the frequency range. Further, it may not perform interleaving on the interleaving reference symbol to determine it as an interleaving reference.

Further, it may not perform interleaving on the interleaving reference sub-carrier to determine it as an interleaving reference. The interleaving reference sub-carrier may be different for each symbol.

Meanwhile, when it perform interleaving in both the time range and the frequency range, it may not perform interleaving on the interleaving reference sub-carrier in the interleaving reference symbol in order to determine it as an interleaving reference.

Punchuring may be used for reducing a data transfer rate and it may be performed at least any one of before and after interleaving. When a wireless environment is good, the exactness of transmitted data is high and the possibility of an error is low, so the number of punchuring data can be reduced.

Further, the transmission exactness of data is higher when a low modulation is used than when a high modulation is used, so the number of punchuring data can be reduced.

Similarly, it can perform automatic gain adjustment on the basis of data received from the first terminal 200 or the second terminal 300. In this case, since the exactness of data is high and the possibility of an error is low, when a wireless environment is good, it is possible to reduce the number of automatic gain adjustment symbols less tan when the wireless environment is poor.

Further, the transmission exactness of data is higher when a high modulation is used than when a low modulation is used, so the number of punchuring data can be reduced.

All of the symbols may be used, if necessary, but reliability of data demodulation is excellent only when automatic gain adjustment is performed on the earlier period of a sub-frame, so the symbols at the earlier period of the sub-frame may be used first.

The present invention can adaptively reduce the calculation amount for device-to-device communication data in accordance with the channel environment or the modulation type, by using punchuring or automatic gain adjustment.

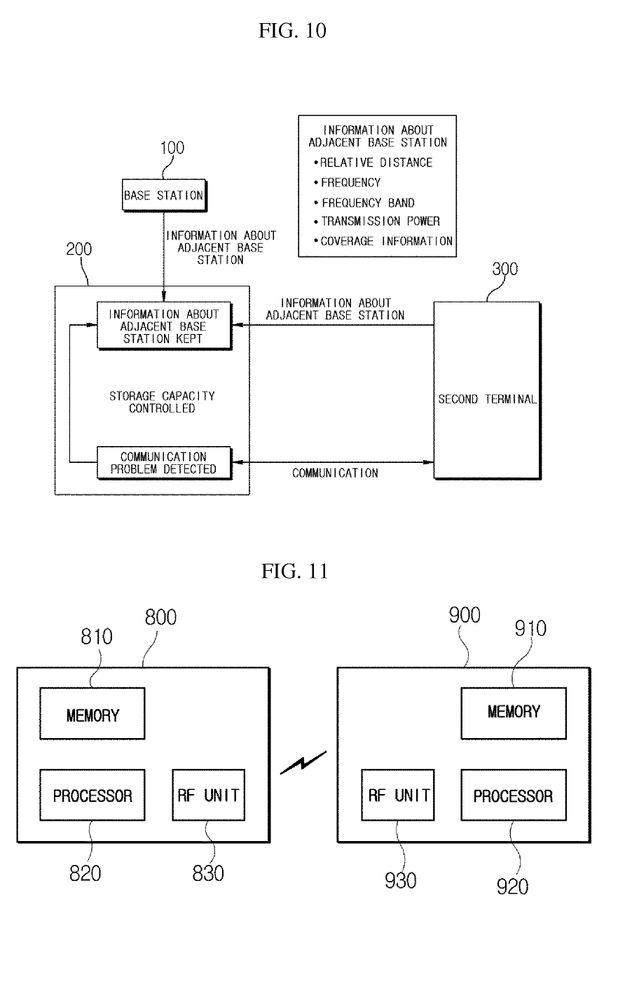

FIG. 10 is a diagram illustrating a configuration for a terminal of FIG. 7 to keep information about an adjacent base station.

The communication system for LTE device-to-device communication shown in FIG. 10 may include a base station 100, a first terminal 200, and a second terminal 300. The first terminal 200 can receive the information about an adjacent base station from at least any one of the base station 100 and the second terminal 300 and perform device-to-device communication with the second terminal 300.

The first terminal 200 may keep the information about sixteen or less adjacent base stations and then perform device-to-device communication by minimizing interference with the adjacent base stations, or may keep the information about basically three or less adjacent base stations, further keep the information about maximum sixteen base stations when it is insufficient, and then perform device-to-device communication by minimizing interference with the adjacent base stations.

Further, when there is a communication problem over a communication problem standard value in communication with the second terminal 300, the first terminal 200 expands the information about adjacent base stations, and when there is a communication problem under the communication problem standard value in communication with the second terminal 300, the first terminal 200 can remove the information about adjacent base stations from the base station farthest from the first terminal 200.

The first terminal 200 can keep the positions of the information about adjacent base stations as relative distances such as one-dimensional two-dimensional, and three-dimensional distances from the first terminal 200.

The first terminal 200 may additionally receive information such as the information of frequencies, frequency bands, transmission power, and coverage of adjacent base stations, in addition to the information about the locations of adjacent base stations.

That is, in device-to-device communication, the first terminal 200 can perform reliable device-to-device communication with the second terminal 300 by finding out the characteristics of adjacent base stations. In this case, sixteen or less base stations can be discriminated in 4 bits in order to sufficiently discriminate the information about base stations.

On the other and, it takes many resources to manage adjacent base stations in order to manage the information about adjacent base stations, so that it may be possible to manage the information about only minimum four or less adjacent base stations, and expand the number, if necessary.

For the number of the information about adjacent base stations to be managed, the first terminal 200 measures the quality of a wireless channel between the first terminal 200 and the second terminal 300, and when the wireless quality is good, it means that there is less interference by adjacent base stations, so the minimum number of adjacent base stations are managed, or when the quality of the wireless channel is poor, it means that interference by adjacent base stations is large, so the number of adjacent base stations to be managed can be expanded.

The information about an adjacent base station may include any one of one-dimensional distance information, two-dimensional vector information, and three-dimensional location information. Further, when the information about adjacent base stations is expanded, the information about the closest adjacent base station may be included first in the information, or when the information about adjacent base stations is reduced, the information farthest from the first terminal 200 may be removed first.

The information about an adjacent base station may include not only the location, but the information about the frequency, the frequency band, the transmission power, and the coverage of the adjacent base station.

The present invention, as described above, can reduce the calculation amount for unnecessary data by adjusting the number of items of information about adjacent base stations that are used, in order to adaptively remove interference according to the communication environment.

FIG. 11 is a block diagram illustrating a wireless communication system for which exemplary embodiments of the present invention can be achieved. The wireless communication system shown in FIG. 8 may include at least one base station 800 and at least one terminal 900.

The base station 800 may include a memory 810, a processor 820, and an RF unit 830. The memory 810 is connected with the processor 820 and can keep commands and various terms of information for activating the processor 820. The RF unit 830 is connected with the processor 820 and can transmit/receive wireless signals to/from an external entity. The processor 820 can execute the operations of the base stations in the embodiments described above. In detail, the operations of the base stations 100, 101, and 201 etc. in the embodiments described above may be achieved by the processor 820.

The terminal 900 may include a memory 910, a processor 920, and an RF unit 930. The memory 910 is connected with the processor 920 and can keep commands and various terms of information for activating the processor 920. The RF unit 930 is connected with the processor 920 and can transmit/receive wireless signals to/from an external entity. The processor 920 can execute the operations of the terminals in the embodiments described above. In detail, the operations of the terminals 200, 300, 301, and 400 etc. in the embodiments described above may be achieved by the processor 920.

The present invention may be modified in various ways and implemented by various exemplary embodiments, so that specific exemplary embodiments are shown in the drawings and will be described in detail.

However, it is to be understood that the present invention is not limited to the specific exemplary embodiments, but includes all modifications, equivalents, and substitutions included in the spirit and the scope of the present invention.

Terms used in the specification, ‘first’, ‘second’, etc., may be used to describe various components, but the components are not to be construed as being limited to the terms. The terms are used to distinguish one component from another component. For example, the ‘first’ component may be named the ‘second’ component, and vice versa, without departing from the scope of the present invention.

The term ‘and/or’ includes a combination of a plurality of items or any one of a plurality of terms.

It should be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, numerals, steps, operations, components, parts, or a combination thereof, but do not preclude the presence or addition of one or more other features, numerals, steps, operations, components, parts, or a combination thereof.

Unless indicated otherwise, it is to be understood that all the terms used in the specification including technical and scientific terms has the same meaning as those that are understood by those skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present invention will be described in more detail with reference to the accompanying drawings. In order to facilitate the general understanding of the present invention in describing the present invention, through the accompanying drawings, the same reference numerals will be used to describe the same components and an overlapped description of the same components will be omitted.

In one or more exemplary embodiments, the described functions may be achieved by hardware, software, firmware, or combinations of them. If achieved by software, the functions can be keep or transmitted as one or more orders or codes in a computer-readable medium. The computer-readable medium includes all of communication media and computer storage media including predetermined medial facilitating transmission of computer programs from one place to another place.

If achieved by hardware, the functions may be achieved in one or more ASICs, DSPs, DSPDs, PLDs, FPGAs, processors, controllers, microcontrollers, microprocessors, other electronic units designed to perform the functions, or combinations of them.

If achieved by software, the functions may be achieved by software codes. The software codes may be kept in memory units and executed by processors. The memory units may be achieved in processors or outside processors, in which the memory units may be connected to processors to be able to communicate by various means known in the art.

Although the present invention was described above with reference to exemplary embodiments, it should be understood that the present invention may be changed and modified in various ways by those skilled in the art, without departing from the spirit and scope of the present invention described in claims.

What is claimed is:

1. An apparatus for transmission on device-to-device communication, comprising:
an RF unit that transmits and receives wireless signals; and
a processor that is connected to the RF unit,
wherein the processor performs device-to-device communication by transmitting a synchronization signal for terminals and a discovery signal to a second terminal and receiving a response to the signals from the second terminal.

2. The apparatus of claim 1, wherein the processor uses, as a parameter, at least any one of using a value under a specific value of codes under ½ as a turbo code and using ½ as a default, of using 80 MHz or less as a bandwidth and using 20 MHz as a default, of using any one of FDD and TDD as a duplex mode and using TDD as a default, of using any modulation type under 64QAM as a modulation type and using 64QAM as a default, and of using ‘normal’ and ‘extended’ as a cyclic prefix (CP) and using ‘normal’ as a default.

3. The apparatus of claim 2, wherein the synchronization signal between terminals includes a PD2DSS (primary D2D synchronization signal) and an SD2DSS (secondary D2D synchronization signal), and
when the extended CP symbol is used, the PD2DSS is positioned at the number zero or the number one of a first slot of a sub-frame and the SD2DSS is positioned at the number three or the number four of a second slot of the sub-frame.

4. An apparatus for transmission on device-to-device communication, comprising:
an RF unit that transmits and receives wireless signals; and
a processor that is connected to the RF unit,
wherein the processor performs device-to-device communication with a second terminal and does not receive at least any one period of time and frequency that are not necessarily received in signals from the second terminal.

5. The apparatus of claim 4, wherein when there are frequencies that are not necessarily received and there are five or less sub-carriers of 1024 sub-carriers that are necessarily received, the processor reduces the processing time by using at least any one of reducing the processing time using DFT instead of FFT signal processing, reducing the processing time by demodulating only necessary sub-carriers in the FFT signal processing, and reducing the processing time by performing FFT signal processing with an LUT (look up table) for sub-carriers that are necessarily received.

6. An apparatus for transmission on device-to-device communication, comprising:
an RF unit that transmits and receives wireless signals; and
a processor that is connected to the RF unit,
wherein the processor performs device-to-device communication with a second terminal and transmits data by performing interleaving on a physical channel that is used for device-to-device communication.

7. The apparatus of claim 6, wherein the processor performs at least any one of interleaving in a frequency range and interleaving in a time range.

8. The apparatus of claim 7, wherein the processor does not perform interleaving in at least any one type of not performing the interleaving on an interleaving reference symbol when performing the interleaving in a frequency range, not performing the interleaving on an interleaving reference sub-carrier when performing the interleaving in a time range, and not performing the interleaving on an interleaving reference sub-carrier at the interleaving reference symbol when performing the interleaving in both the frequency range and the time range

9. The apparatus of claim 8, wherein the processor performs at least any one of designating one or more symbol per sub-frame as the interleaving reference symbol, designating one or more sub-carriers per sub-frame as the interleaving reference sub-carrier, and designating a different interleaving reference sub-carrier for each symbols.

10. The apparatus of claim 6, wherein the processor performs at least any one of punchuring in the frequency range and punchuring in the time range on at least any one of before and after the interleaving.

11. The apparatus of claim 10, wherein when a wireless channel environment between the apparatus and the second terminal is good, the processor performs punchuring over the number of times of punchuring, which is performed for a poor wireless channel environment.

12. The apparatus of claim 10, wherein the processor performs punchuring over the number of times of punchuring performed for a high-level modulation type, when a low-level modulation type is used.

13. The apparatus of claim 6, wherein the processor performs automatic gain adjustment on the basis of an automatic gain adjustment reference symbol of device-to-device communication symbols transmitted from the second terminal.

14. The apparatus of claim 13, wherein the processor demodulates the symbols that have undergone the automatic gain adjustment, on the basis of automatic gain values in the automatic gain adjustment.

15. The apparatus of claim 14, wherein when a wireless channel environment between the apparatus and the second terminal is poor, the processor performs automatic gain adjustment, using reference symbols over the number of the automatic gain adjustment reference symbols used for a good wireless channel environment.

16. The apparatus of claim 14, wherein the processor performs automatic gain adjustment, using reference symbols over the number of the automatic gain adjustment reference symbols used for a low-level modulation type, when a high-level modulation type is used.

17. An apparatus for transmission on device-to-device communication, comprising:
an RF unit that transmits and receives wireless signals; and
a processor that is connected to the RF unit,
wherein the processor receives information about an adjacent base station from at least any one of a base station and a second terminal and performs device-to-device communication with the second terminal.

18. The apparatus of claim 17, wherein the processor keeps the information about sixteen or less adjacent base stations and then performs device-to-device communication by minimizing interference with the adjacent base stations, or keeps the information about basically three or less adjacent base stations, further keeps the information about maximum sixteen base stations when it is insufficient, and then performs device-to-device communication by minimizing interference with the adjacent base stations.

19. The apparatus of claim 18, wherein when there is a communication problem over a communication problem standard value in communication with the second terminal, the processor expands the information about adjacent base stations, and when there is a communication problem under the communication problem standard value in communication with the second terminal, the processor removes the information about adjacent base stations from the base station farthest from the apparatus.

20. The apparatus of claim 17, wherein the processor keeps the positions of the information about adjacent base stations as relative distances such as one-dimensional, two-dimensional, and three-dimensional distances from the apparatus.

21. The apparatus of claim 17, wherein the processor additionally receives at least any one the information of frequencies, frequency bands, transmission power, and coverage of adjacent base stations, in addition to the locations of adjacent base stations.
